(19) United States
(12) Patent Application Publication
(10) Pub. No.: US 2019/0111527 A1
(43) Pub. Date: Apr. 18, 2019

(54) Brazing Techniques And Articles Produced By Brazing

(71) Applicant: Continental Automotive GmbH, Hannover (DE)

(72) Inventors: Giandomenico Serra, Ghezzano-S.Giuliano Terme (PI) (IT); Gisella Di Domizio, San Giuliano Terme (IT); Massimo Giovannetti, Scandicci (IT); Georg Weigl, Regensburg (DE)

(73) Assignee: Continental Automotive GmbH, Hannover (DE)

(21) Appl. No.: 16/156,110

(22) Filed: Oct. 10, 2018

(30) Foreign Application Priority Data
Oct. 12, 2017 (EP) 17196151

(51) Int. Cl. B23K 37/06; B23K 1/008; B23K 1/00; F02M 55/02; F02M 55/00

(52) U.S. Cl. CPC B23K 37/06; B23K 1/008; B23K 35/0227; F02M 55/025; F02M 55/004; B23K 1/0008

(57) ABSTRACT

Various embodiments may include a fuel rail assembly comprising: a fuel rail; a second component; and a brazed joint securing the fuel rail and the second component together. The brazed joint may include a brazing filler material distributed between a first joining area formed by a surface portion of the fuel rail and second joining area formed by a surface portion of the second component. At least one of the joining areas comprises an elongated slot adapted to contain the brazing filler material.

### CROSS-REFERENCE TO RELATED APPLICATIONS

This application claims priority to EP Application No. 17196151 filed Oct. 12, 2017, the contents of which are hereby incorporated by reference in their entirety.

### TECHNICAL FIELD

The present disclosure relates to brazing techniques. Various embodiments may include a brazed article and/or a method for producing a brazed article, particularly but not exclusively for components of a fuel rail assembly for internal combustion engines.

### BACKGROUND

Producing brazed joints to connect two components typically comprises applying a brazing filler material to the components, bringing the two components together with the filler material therebetween and subjecting the components with the brazing filler material to heat in a furnace for melting the brazing filler material. The quality of the brazed joint is dependent upon the filler material extending over the entire intended area as it melts in the furnace, and there is a risk that the brazing is incomplete or there is no brazing in certain areas, which may be due to insufficient heat transfer to the filler material or to failure of the filler material to extend over the entire intended area.

### SUMMARY

The teachings of the present disclosure may provide a brazed article with a reliable brazed joint and particularly a method for producing such a brazed article. The teachings of the present disclosure are particularly but not exclusively applicable for brazing together components of a fuel rail assembly for internal combustion engines. Fuel rail assemblies operate in a harsh environment with high temperatures, high pressures, and vibrations and in order to ensure reliability and durability the components for such assemblies, when brazed together, have the required degree of reliability and durability.

### BRIEF DESCRIPTION OF THE DRAWINGS

Further advantages, embodiments, and developments of the teachings herein, in particular as used in a fuel assembly, and methods for producing the same will become apparent from the embodiments described below with reference to the accompanying informal drawings, in which:

FIG. 1A shows a side view of a schematic view of part of a fuel rail assembly incorporating teachings of the present disclosure;

FIG. 1B shows a plan view of FIG. 1;

FIG. 1C shows a sectional view along the line A-A of FIG. 1A;

FIG. 1D shows a perspective view of the fuel rail assembly of FIG. 1A;

FIGS. 2A-2C show alternative examples incorporating teachings of the present disclosure; and

FIG. 3 shows an example embodiment with only one slot incorporating teachings of the present disclosure.

### DETAILED DESCRIPTION

Various embodiments of the present disclosure may include a brazed article comprising a first component and a second component and a brazed joint therebetween to secure the first and second components together by means of a brazing filler material distributed between a first joining area formed by a surface portion of the first component and second joining area formed by a surface portion of the second component, wherein one or both of the joining areas have formed therein at least one elongate slot adapted to contain a brazing material. Two or more second components may be secured to the first component by respective brazed joints, whereby one or both of the joining areas comprise at least one elongate slot adapted to contain a brazing material.

In some embodiments, the brazed article is a fuel rail assembly and the first component comprises a fuel rail. The second component may be secured to an outer surface of the fuel rail by the brazed joint. The second component may be a fuel adapter for connecting the fuel rail with a fuel injector, for example. The brazed joint may be formed between a base of the fuel adapter and the outer surface of the fuel rail. The second component may also be a fixing bracket, for example for fixing the fuel rail to an internal combustion engine.

In some embodiments, the slot or slots extend across substantially the entire breadth of the joining area or areas. The breadth is the dimension of the respective joining area in direction along an elongation direction of the fuel rail. It is also conceivable that the slot or slots extend across substantially the entire height of the joining area or areas, the height being the dimension of the joining area along an intersection line of the joining area with a plane perpendicular to the elongation direction of the fuel rail.

In some embodiments, two spaced elongate slots are provided, each being adapted to contain a brazing material. Each of the slots may be a slot according to one of the above-mentioned embodiments and developments. In some embodiments, the slots are mutually parallel. In some embodiments, the slots are curved but still non-intersecting. In this case, the planes spanned by each of the slots may be parallel. The slots may be congruent in top view on these planes. In some embodiments, the slot or slots extend across the entire extent of the adjoining area so as to be visually exposed at the edges of the joining area.

In some embodiments, the brazing material may comprise a wire or a brazing paste. When the brazing material comprises a wire, the wire may be located in the associated slot with an interference fit along its entire length. In some embodiments, the interference fit extends over only part of the slot; in this case, the wire may be in loose fit with the other part or parts of the slot. This interference fit enables the brazing material to be fastened to the joining area in the desired position by a mechanical connection that does not require any additional fixing means, such as adhesive. This simplifies handling of the components before brazing to produce the brazed joint that secures the two components together. The slots and the interference fit with wire may be used to braze substantially flat surfaces or curved surfaces or arcuate surfaces together rather than tubular surfaces, e.g. pipe-in-pipe overlapping joints.

In some embodiments, the joining area of the brazed joint has one dimension greater than another, in which case, the slot or slots may extend in the direction of the greater dimension. This arrangement may facilitate the brazing material extending over the entire joining area of the brazed joint. To facilitate the uniform spreading of the brazing material, when two or more slots are provided, the two or more slots may be in spaced parallel relationship. In some embodiments, the slots are discontinuous along the overall length of the slots to assist in the melting brazing material extending over the joining area in a more uniform manner.

In some embodiments, to facilitate the uniform spreading of the brazing material during the melting stage, the brazing material is discontinuous along the overall length of the slots. In some embodiments, the depth and width of the slot is varied along its length. In some embodiments, the greatest depth and/or width of the slots is in the mid-region of the slot.

In some embodiments, the brazing material comprises a copper wire or a copper-based brazing material in the form of a wire.

In some embodiments, an outer surface of first component comprises a profile surface providing the first joining area and the second component comprises a surface shaped to provide an exterior face to match the profile surface, the exterior face providing the second joining area. The brazed joint may be arranged between the profile surface and the exterior face. The profile surface and the exterior face may be arcuate. In some embodiments, the profile surface comprises a convex surface and the exterior face comprises a concave surface.

Some embodiments may include a fuel rail assembly for fuel injection for an internal combustion engine, comprising a fuel rail having an elongate body forming a reservoir for fuel, and a plurality of fuel outlet ports, and including a brazed article according the disclosure, the first component of the brazed article comprising the fuel rail. The second component may comprise a fuel adapter secured to an outlet port of the fuel rail, the fuel adapter providing a hydraulic communication between the fuel rail and a fuel injector for injecting fuel into the internal combustion engine, or the second component may comprise a fixing bracket for mounting the fuel rail to an internal combustion engine.

In some embodiments, an outer surface of the fuel rail comprises a profile surface providing the first joining area and the fuel adapter or the fixing bracket comprises a surface shaped to provide an exterior face to match the profile surface, the exterior face providing the second joining area, wherein the brazed joint is arranged between the profile surface and the exterior face.

The profile surface and the exterior face may be arcuate. The profile surface may comprise a convex surface, for example a portion of the outer surface of a tubular fuel rail, for example a cylindrical fuel rail, and the exterior face of the fuel adapter or fixing bracket comprises a concave surface that is shaped to match with the profile surface. The exterior surface may be substantially elliptical.

Some embodiments may include a method for producing a brazed article formed of two components, as disclosed above, the method comprising applying a brazing filler material to the first component and/or the second component and melting the brazing filler material so as to distribute the filler material over the first and second joining areas thereby brazing the two components together. Some embodiments may include a method for producing a fuel rail assembly. The first component for the brazed article may be, for example, a fuel rail. The method comprises applying a brazing filler material to the fuel rail and/or the second component and melting the brazing filler material so as to distribute the filler material over the first and second joining areas thereby brazing the two components together. The second component may be a fuel adapter or a fixing bracket for example and be brazed to the outer surface of the fuel rail. The two components and the brazing filler material may be placed in a furnace to melt the filler material and form the brazed joint. In some embodiments, the brazing filler material comprises a wire located in each of the slots, the wire melting to spread across the joining area when the two components and the filler material are heated in a furnace. The wire may be a copper wire or copper-based wire. The brazing filler material may also be applied to the first and/or second joining area in the form of a paste. In some embodiments, the wire is located in the associated slot with an interference fit. The interference fit may extend over only part of the slot or over substantially the entire slot.

In some embodiments, the method may be used to manufacture a fuel rail assembly. For example, in some embodiments, the first component of the brazed article comprises the fuel rail and the second component comprises a fuel adapter secured to an outlet port of the fuel rail. The fuel adapter provides a hydraulic communication between the fuel rail and a fuel injector for injecting fuel into the internal combustion engine. In some embodiments, the method may be used to manufacture a fuel rail assembly, whereby the first component of the brazed article comprises the fuel rail and the second component comprises a fixing bracket for mounting the fuel rail to an internal combustion engine.

An outer surface of the fuel rail may comprise a profile surface providing the first joining area and the fuel adapter or fixing bracket comprises a surface shaped to provide an exterior face to match the profile surface, the exterior face providing the second joining area. The brazed joint is arranged between the profile surface and the exterior face. The profile surface and the exterior face may comprise arcuate surfaces. The profile surface may comprise a convex surface and the exterior face may comprise a concave surface.

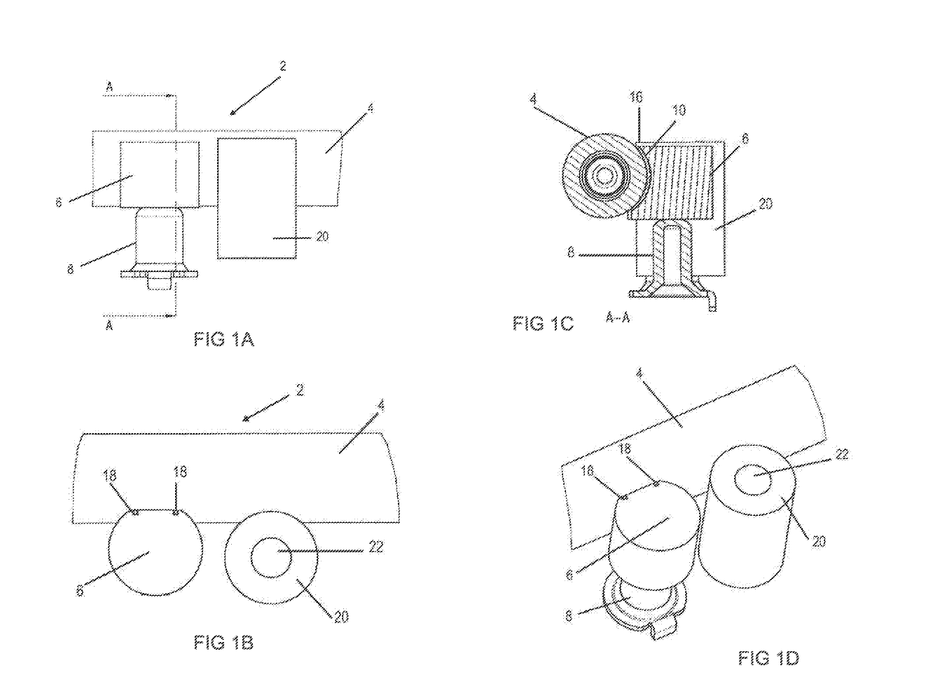

Referring now to FIG. 1A, there is a schematic view of part of a fuel rail assembly of a fuel injection system for an internal combustion engine. The fuel rail assembly 2 has a fuel rail 4 in the form of an elongate substantially tubular body which comprises a reservoir for fuel. Fuel is supplied to the fuel rail 4 through a fuel inlet by a fuel pump (not shown). The fuel rail 4 has a plurality of fuel outlets although only one is illustrated for the sake of simplification. The fuel outlet has connected thereto a fuel adapter 6 which provides a hydraulic communication between the fuel rail 4 and a fuel injector cup 8 which has an open lower end 12 in which is located a fuel inlet of a fuel injector (not shown).

The fuel injector 6 is shaped to abut the exterior of the fuel rail 4 as shown in FIG. 1C which illustrates a cross section along the line A-A of FIG. 1A. In some embodiments, the fuel rail is a tubular body and the fuel adapter 6 has an arcuate joining surface 10 which abuts the fuel rail 4 over a fuel outlet to complete the hydraulic communication between the reservoir in the fuel rail 4 and the fuel injector cup 8. In this way the two joining surfaces mate so that the brazing material between the two surfaces has a uniform thickness across the joining surfaces. In certain embodiments, the mating surfaces may be flat to achieve the desired braze qualities.

The fuel injector 6 is brazed to the fuel rail 4 and a brazing filler material is positioned in between the arcuate joining surface 10 and the surface of the fuel rail 4. The brazing filler material is provided in the form of copper wire which is located in two spaced parallel slots 14 formed in the arcuate surface 10. The ends 18 of the slots extend to the outer edge of the fuel adapter so that the ends 18 of the slots 16 are visible. This facilitates visual checking of the effectiveness of the brazing step, although in other embodiments it is possible to conceal the slots 14 by terminating the slots just inside the outer edge 16 of the fuel adapter 6.

However, the arrangement is not limited to two spaced parallel slots and is not limited to arcuate joining surfaces and arcuate brazed joints. For example, the joining surface may be substantially planar and more than two slots may be provided and the two or more slots may have arrangements other than parallel. For example two slots may extend at an incline angle to one another or perpendicularly to one another.

As shown in FIGS. 1A-1D, a mounting bracket 20, shown schematically, is secured to the fuel rail 4, the mounting bracket 20 serving to enable the fuel rail assembly to be secured to an engine. The mounting bracket 20 is provided with a through bore 22 through which the fuel rail assembly can be bolted to the engine. The mounting bracket 20 can be brazed to the fuel rail 4 in the same manner described with reference to the fuel adapter 6.

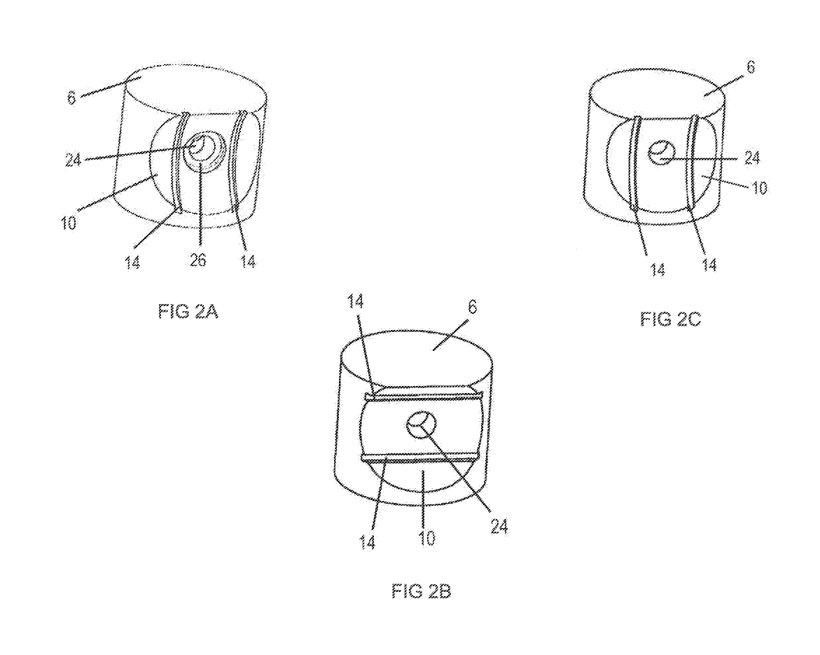

Referring now to FIGS. 2A to 2C there are multiple alternative arrangements distributing the slots 14 in the arcuate joining surface 10 of the fuel adapter 6. In this view, part of the fuel passage 24 leading from the fuel rail 4 to the fuel injector cup 8 is illustrated. In FIG. 2A, the two slots 14 lie in a radial plane of the fuel rail 4 on either side of the fuel passage 24. In addition, in this embodiment, a further ring of brazing material surrounds the periphery of the fuel passage 24.

FIG. 2B illustrates an embodiment in which the slots 14 extend along the longitudinal length of the fuel rail 4. FIG. 2C illustrates an embodiment similar to that of FIG. 2A, without the additional ring 26 of brazing material.

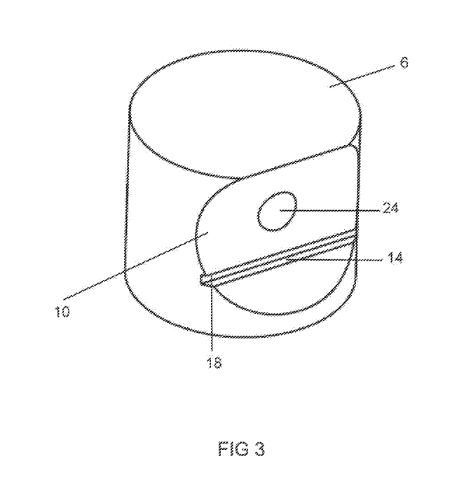

FIG. 3 illustrates an embodiment with only one slot 14. This arrangement may be particularly advantageous in a situation where the brazing area is elongate, with an elongate dimension substantially greater than its dimension at right angles to the elongate dimension.

The size, that is the depth and width of the slots 14, may be selected depending on the parameters required for the installation and both the width and depth may vary along the length of the slots 14. The positioning of the slots 14 will also depend on the precise size and shape of the joining area. If the joining area has one dimension larger than the other, the elongate slots may extend along the length of the larger dimension. The copper wire may be fitted in the slots with an interference fit to prevent inadvertent movement or loss of the copper wire prior to the brazing step. This interference fit may be throughout the length of the slots but may equally be in just certain spots.

Although shown as two straight slots arranged in spaced parallel relationship, the slots may not be parallel and, in fact, may be curved. Also, more than two slots may be provided and the slots may be of different lengths. The precise number and orientation of the slots and their depth and width may vary depending on the particular requirements of an application. In the embodiments shown, the slots are machined in the components, but it is possible that they may be obtained by different technologies such as deforming by pressing or the like, casting, and/or forging.

The embodiments described use a copper wire as the brazing material but other materials may be used as the brazing material wire, such as a copper-based alloy, for example a copper-zinc alloy or silver, nickel, palladium, gold, tin, antimony, or lead-based alloys or alloys containing one or more of these elements.

1. A fuel rail assembly comprising:
a fuel rail;
a second component; and
a brazed joint securing the fuel rail and the second component together;
the brazed joint including a brazing filler material distributed between a first joining area formed by a surface portion of the fuel rail and second joining area formed by a surface portion of the second component;
wherein at least one of the joining areas comprise an elongated slot adapted to contain the brazing filler material.

2. A fuel rail assembly according to claim 1, wherein the elongated slot extends across the entire extent of the joining area and is visually exposed at the edges of the joining area.

3. A fuel rail assembly according to claim 1, wherein the joining area of the brazed joint has one dimension greater than another and the elongated slot extends along the greater dimension.

4. A fuel rail assembly according to claim 1, wherein a depth and a width of the elongated slot vary along a length of the elongated slot.

5. A fuel rail assembly according to claim 1, wherein the at least one of the joining areas comprises two spaced elongated slots.

6. A fuel rail assembly according to claim 5, wherein the two spaced elongated slots are parallel to one another.

7. A fuel rail assembly for fuel injection for an internal combustion engine, the fuel rail assembly comprising:
a fuel rail;
a fuel adapter secured to an outlet port of the fuel rail and providing fluid communication between the fuel rail and a fuel injector for injecting fuel into the internal combustion engine; and
a brazed joint securing the fuel rail and the second component together;
the brazed joint including a brazing filler material distributed between a first joining area formed by a surface portion of the fuel rail and second joining area formed by a surface portion of the fuel adapter;
wherein at least one of the joining areas comprise an elongated slot adapted to contain a brazing material.

8. A method for producing a fuel rail assembly, the method comprising:
applying a brazing filler material to an elongated slot in at least one of a fuel rail and a second component; and
melting the brazing filler material to distribute the filler material over a first joining area in a surface of the fuel rail and a second joining area in a surface of the second component thereby brazing the fuel rail and the second component together.

9. A method according to claim 8, wherein melting the brazing filler material includes placing the fuel rail, the second component, and the brazing filler material in a furnace to melt the brazing filler material.

10. A method according to claim 8, wherein the brazing filler material comprises a wire located in the elongated slot and the wire spreads across the respective joining areas when the filler material is melted.

11. A method according to claim 7, wherein the brazing filler material comprises a wire disposed in the elongated slot with an interference fit.

12. A method according to claim 11, wherein the interference fit extends over only part of the elongated slot.

13. A method according to claim 8, wherein the brazing filler material comprises a copper wire.

14. A method according to claim 8, wherein the second component comprises a fuel adapter secured to an outlet port of the fuel rail, the fuel adapter providing a hydraulic communication between the fuel rail and a fuel injector for injecting fuel into the internal combustion engine.

15. A fuel rail assembly for fuel injection for an internal combustion engine, the fuel rail assembly comprising:
a fuel rail;
a fixing bracket for mounting the fuel rail to an internal combustion engine; and
a brazed joint securing the fuel rail and the fixing bracket together;
the brazed joint including a brazing filler material distributed between a first joining area formed by a surface portion of the fuel rail and second joining area formed by a surface portion of the fixing bracket;
wherein at least one of the joining areas comprise an elongated slot adapted to contain a brazing material.

16. A method according to claim 8, wherein the second component comprises a fixing bracket for mounting the fuel rail to an internal combustion engine.
